(19) United States
(12) Patent Application Publication
(10) Pub. No.: US 2007/0064547 A1
(43) Pub. Date: Mar. 22, 2007

(54) Optical disc recorder

(75) Inventors: Hiroyuki Kameda, Daito-shi (JP); Ryusuke Noda, Daito-shi (JP); Hironori Tani, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/519,003

(22) Filed: Sep. 12, 2006

(30) Foreign Application Priority Data
Sep. 13, 2005 (JP) 2005-265775

(51) Int. Cl. G11B 21/08

(52) U.S. Cl. 369/30.19

(57) ABSTRACT

In an optical disk recorder (1), when a user instruct to format an optical disc (2), a main control unit 3 reads out file management data from a file management data area of the optical disc (2), and writes the read file management data at a specific area of the optical disc (2) through an optical head (6) so as to save the read file management data. When the user instruct to cancel the formatting of the optical disc (2), the main control unit (3) reads out the saved file management data from the optical disc (2) and rewrite the saved file management data into the original file management data area again. Thereby, the user can use the user data recorded before the formatting of the optical disc (2).

### BACKGROUND OF THE INVENTION

1. Field of the Invention

The present invention relates to an optical disk recorder having a formatting function of an optical disk.

2. Description of the Related Art

Conventionally, an optical disc recorder has a function for formatting an optical disc further to functions for recording data into the optical disc and reproducing the data recorded in the optical disc. Data recordable optical disc includes write-once optical discs into which the data can be written only once and rewritable optical discs into which data can be rewritten repeatedly by a predetermined times. As for the write-once optical disc, CD-R (CD Recordable), DVD-R (DVD Recordable), DVD+R (DVD Recordable) are exemplified. Furthermore, as for the rewritable optical disc, CD-RW (CD Rewritable), DVD-RW (DVD Rewritable), DVD+RW (DVD Rewritable), DVD-RAM (DVD Random Access Memory) are exemplified.

For using the optical disc, it is necessary to perform sectioning operation on the optical disc to store the data, and to form directories into which information of data stored in specific areas is recorded. This operation is called a logical format (hereinafter, it is simply called “format” or “formatting”), and the format depends on OS (Operating System) of the optical disk recorder.

In the case of the rewritable optical disk, data written into the optical disc can be erased, new data can be overwritten into the optical disc, and the optical disc can be formatted. When writing or reading data into or from the optical disc becomes unstable due to repeated use over the years, it is possible to stabilize the writing and reading of the data by formatting the rewritable optical disc. However, when the optical disc is formatted, all the data stored in the optical disc are erased. If a user erroneously formats the optical disc, or when a person other than the user formats the optical disc intentionally or inadvertently, the user cannot use the data which were stored in the optical disc before the formatting operation. The same goes for magnetic disc.

In order to prevent the loss of the data due to formatting, Japanese Laid-Open Patent Publication No. 3-103916 discloses a formatting method of a magnetic disc that data stored on tracks to be formatted are evacuated onto unused tracks, and the tracks to be formatted are formatted after the evacuation of the data. The data evacuated onto the unused tracks are restored onto the formatted tracks. However, when there is no unused track, the data cannot be evacuated, so that the data may be lost due to performing the format.

On the other hand, Japanese Laid-Open Patent Publication No. 2004-206291 discloses a conventional data recorder that data on a track is evacuated into a RAM (Random Access Memory) and the track from which the data are evacuated is formatted one by one, when a disc is formatted. The data evacuated into the RAM are restored onto the formatted track. The data recorder, however, needs the RAM for storing the data other than the disc, so that it causes to increase the cost of the data recorder. Furthermore, when the data recorder or another auxiliary device uses the same RAM for a function other than formatting, the function may be restricted due to the use of the RAM by formatting operation.

Furthermore, Japanese Laid-Open Patent Publication No. 63-285777 discloses a formatting method that information of a magnetic disc apparatus such as alternate information is stored into a memory before formatting the magnetic disc apparatus, and the information stored in the memory is reused after formatting. Data stored on the tracks to be formatted, however, are not evacuated in the formatting operation, so that the data may be lost due to the format, and the user cannot be used the data after the format.

Still furthermore, Japanese Laid-Open Patent Publication No. 62-275357 discloses a method for evacuating track format information that the track format information of all tracks is read out from a magnetic disc, and the format information is written into a specific area of the magnetic disc before formatting the magnetic disc. The evacuated track format information is reused after formatting. Data stored on the tracks to be formatted, however, are not evacuated in the formatting operation, so that the data may be lost due to the format, and the user cannot be used the data after the format.

### SUMMARY OF THE INVENTION

A purpose of the present invention is to provide an optical disc recorder that data stored in an optical disc before formatting the optical disc can be reused after formatting, and manufacturing cost thereof can be decreased due to reduction of components.

An optical disc recorder in accordance with an aspect of the present invention comprises: a data writing means for writing data into an optical disc; a data reading means for reading out data from an optical disc; a disc formatting means for formatting an optical disc by erasing file management data written in a file management data area of the optical disc; a format instruction means, which is operated by a user, to instruct to perform formatting of an optical disc to the disc formatting means; and a format instruction cancel means, which is operated by the user, to instruct to cancel the formatting of the optical disc to the disc formatting means.

When the format instruction means instructs to perform formatting of an optical disc, the data reading means reads out file management data from file management data area of the optical disc before erasing the file management data, and the data writing means writes the file management data into a specific area of the optical disc except the file management data area so as to save the file management data, and subsequently, the disc formatting means erases the file management data originally written in the file management data area thereby formatting the optical disc.

When the format instruction cancel means instructs to cancel the formatting of the optical disc, the data reading means reads out the file management data saved in the specific area of the optical disc, and the data writing means writes the file management data read out from the specific area into the file management data area where the file management data was originally written.

According to such a constitution, even when the user erroneously formats the optical disc, or when a person other than the user formats the optical disc intentionally or inadvertently, since the file management data originally written in the file management data area was saved in the specific area of the optical disc except the file management data area, the file management data can be returned to the file management data area by operating the format instruction cancel means. Thereby, the user can use the data which were stored in the optical disc before the formatting operation. Furthermore, since the file management data are saved in the specific area of the same optical disc, another recording media becomes unnecessary to save the file management data, and thereby, the cost of the optical disc recorder can be reduced due to reduction on number of elements constituting the optical disc recorder.

### BRIEF DESCRIPTION OF THE DRAWINGS

FIG. 1 is a block diagram showing a constitution of an optical disk recorder in accordance with a first embodiment of the present invention;

FIGS. 2A to 2F are diagrams each showing a data structure of an optical disk such as a DVD-RW used for the above optical disk recorder;

FIG. 3 is a flowchart showing a formatting operation of the above optical disk recorder for formatting the optical disk in the first embodiment;

FIGS. 4A and 4B are diagrams respectively showing a data structure of an optical disk such as a DVD+RW used for the optical disk recorder in accordance with a second embodiment of the present invention; and

FIG. 5 is a flowchart showing a formatting operation of the optical disc recorder for formatting the optical disc in the second embodiment.

### DETAILED DESCRIPTION OF THE EMBODIMENTS

First Embodiment

An optical disc recorder in accordance with a first embodiment of the present invention is described with reference to the figures. An optical disc used for the optical disc recorder in the first embodiment is, for example, a DVD-RW, and the optical disc recorder is, for example, a DVD recorder which records and/or reproduces data of images, sounds, voices, and so on.

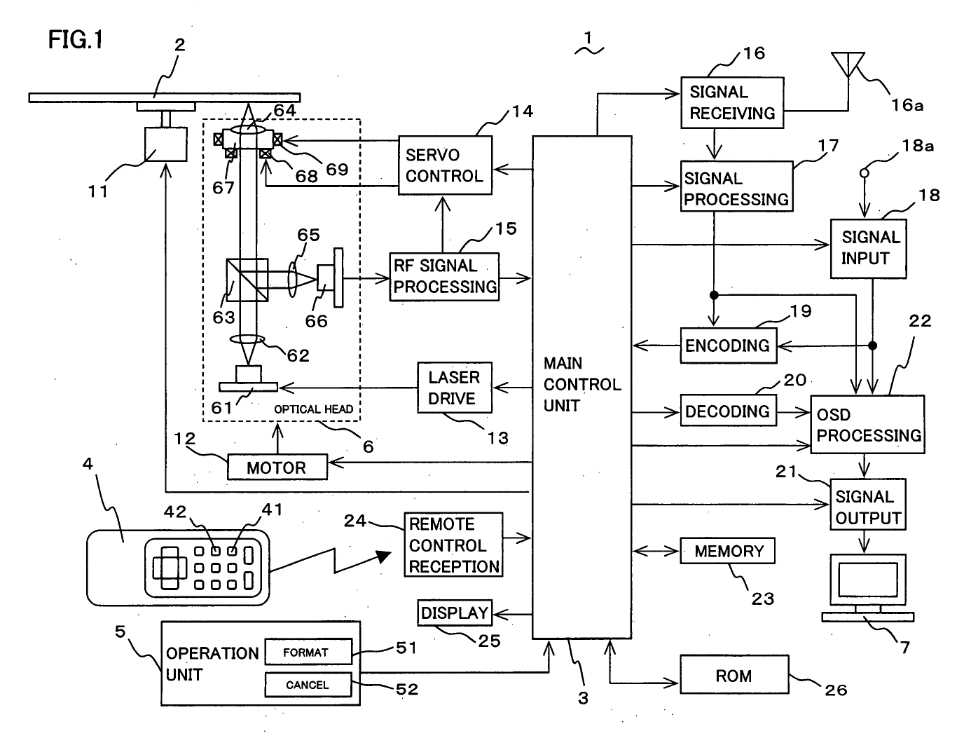

FIG. 1 shows a constitution of an optical disk recorder 1. The optical disk recorder 1 serves to record data into an optical disk 2 and to read out date from the optical disk 2. The optical disc recorder 1 has a main control unit 3 comprised of a CPU and so on for controlling entire of the optical disk recorder 1, a remote controller 4 and an operation unit 5 which is operated by a user to issue instructions to the main control unit 3 and an optical head 6 for writing and/or reading data. The optical disk recorder 1 is connected to a monitor display apparatus 7 for displaying a menu picture to render the user for selecting various operations.

The optical disk 2 is inserted into a disk insertion unit such as a tray (not shown) and attached to a spindle motor 11. The spindle motor 11 is rotationally driven by the main control unit 3 and rotates the optical disk 2 attached thereto. A driving motor 12 is formed of a linear motor and reciprocally moves the optical head 6 in a radial direction of the optical disk 2 with facing a recording face of the optical disc 2.

The optical head 6 writes data into the optical disk 2 by forming a pit on the recording face of the optical disk 2 and reads out data recorded in the optical disk 2 by detecting the pits formed on the recording face of the optical disk 2. The optical head 6 comprises a semiconductor laser 61, a collimator lens 62, a beam splitter 63, an objective lens 64, a condenser lens 65 and a light receiving element 66.

The semiconductor laser 61 is driven by a laser driving unit 13 to emit a light beam. The light beam emitted from the semiconductor laser 61 is focused and irradiated on the optical disk 2 through the collimator lens 62, the beam splitter 63 and the objective lens 64. The light reflected on the optical disk 2 is focused on the light receiving element 66 through the objective lens 64, the beam splitter 63 and the condenser lens 65. The objective lens 64 is held on a lens holder 67 and moved due to magnetic action of a focusing coil 68 and a tracking coil 69 which are driven and controlled by a servo control unit 14 in a direction vertical to the recording face of the optical disk 2 and in the radial direction of the optical disk 2. With the movement of the objective lens 64, position of a focused point and beam spot diameter of the light which is emitted from the semiconductor laser 61 and focused on the optical disk 2 are adjusted. A light receiving face of the light receiving element 66 is divided into a plurality of areas and each areas of the light receiving surface outputs electrical signals according to received light intensity.

The optical head 6 with such configuration radiates the light beam emitted from the semiconductor laser 61 to the optical disk 2, thereby altering a recording layer of the optical disk 2 to form a pit on the optical disk 2. Reflectance of the light is changed at the altered portion of the recording layer. The optical head 6 radiates the light beam emitted by the semiconductor laser 61 to the optical disk 2 and the light receiving element 66 receives the light reflected on the optical disk 2, thereby detecting the pit formed on the recording layer of the optical disk 2. For detecting the existence of the pit on the recording layer of the optical disc, intensity of the light beam emitted from the semiconductor laser 61 is decreased so as not to alter the recording layer of the optical disk 2.

The laser driving unit 13 controls timing for emitting the light beam and intensity of the light beam emitted from the semiconductor laser 61 based on the signal from the main control unit 3. An RF signal processing unit 15 generates and outputs an RF signal (reflection intensity signal), a focusing error signal and a tracking error signal based on output signals from the light receiving element 66. The servo control unit 14 drives the focusing coil 68 and the tracking coil 69 based on the focusing error signal and the tracking error signal from the RF signal processing unit 15, thereby moving the objective lens 64 to control position of the focused point of the light beam irradiated from the semiconductor laser 61 onto the optical disk 2.

A broadcast signal reception unit 16 receives a TV broadcast signal via an antenna 16a based on a signal from the main control unit 3 so that receiving frequency of it is tuned to frequency of the TV broadcast signal delivered from a broadcast station. A received signal processing unit 17 demodulates the TV broadcast signal received by the broadcast signal reception unit 16 to generate audio signals and visual signals corresponding to a signal from the main control unit 3. A signal input unit 18 is operated corresponding to a signal from the main control unit 3. Various signals representing data such as video, music and documents are inputted to the signal input unit 18 from external equipment (not shown) such as a video camera, a digital camera and a personal computer.

An encoding unit 19 encodes the audio signals and the visual signals generated by the received signal processing unit 17 and the signals inputted from the signal input unit 18 into a predetermined format based on a signal from main control unit 3 so as to record these signals on the optical disk 2 as encoded data. A decoding unit 20 decodes the encoded data read from the optical disk 2 corresponding to a signal from the main control unit 3.

A signal output unit 21 outputs the audio signals and the visual signals generated by the received signal processing unit 17, the signals inputted from the signal input unit 18 and the signals decoded by the decoding unit 20 to external equipment such as the monitor 7, a speaker and a personal computer (not shown) based on a signal from main control unit 3. An OSD (On Screen Display) processing unit 22 superimposes an on-screen image signal for displaying an on-screen image on the monitor 7 on the video signals decoded by the received signal processing unit 17, the signals inputted from the signal input unit 18 and the signals decoded by the decoding unit 20 corresponding to a signal from the main control unit 3.

A memory 23 temporarily stores code data to be recorded in the optical disc 2 and code data read from the optical disk 2 based on a signal from the main control unit 3. In addition, the memory 23 stores graphical data to generate an onscreen picture.

The remote controller 4 is operated by the user to instruct various operations of the optical disk recorder 1 including selection of a receiving channel of the TV broadcast signal, recording of data such as video, music and documents on the optical disk 2 and reproduction of the data stored in the optical disk 2. The remote controller 4 has various operation keypads operated by the user to instruct various operations of the optical disk recorder 1 and by operating each of the various operation keypads, outputs an infrared code signal associated with the respective operation. The various operation keypads include a format key 41 serving as a format instruction means and a format cancel key 42 serving as a format instruction cancel means. When the user operates the format key 41, the remote controller 4 instructs the main control unit 3 to perform the formatting of the optical disk 2. When the user operates the format cancel key 42, the remote controller 4 instructs the main control unit 3 to cancel the format instruction.

A remote controller reception unit 24 receives infrared light signals transmitted from the remote controller 4, converts the signal into an electrical signal and outputs the electric signal corresponding to the operation of the remote controller 4 to the main control unit 3. A display unit 25 is provided in the main unit of the optical disk recorder 1 and displays the operation performed by the remote controller 4 and an operating state of the optical disk recorder 1 thereon. A ROM (Read Only Memory) 26 stores an operation program of the main control unit 3 therein.

The operation unit 5 has various operation buttons operated by the user to instruct various operations of the optical disk recorder 1 including recording of data such as video signals into the optical disk 2 and reproduction of the data recorded in the optical disk 2 and by operating each of the various operation buttons, outputs a signal associated with the respective operation to the main control unit 3. The operation unit 5 includes a format button 51 serving as a format instruction means and a format cancel button 52 serving as a format instruction cancel means. When the user operates the format button 51, an instruction to perform the formatting the optical disk 2 is issued to the main control unit 3. When the user operates the format cancel button 52, an instruction to cancel the format instruction is issued to the main control unit 3.

The monitor display apparatus 7 displays various menu pictures on a screen thereof based on a signal from the main control unit 3. The monitor display apparatus 7 has an item to instruct the formatting of the optical disc 2 in a menu picture. When the user operates the remote controller 4 or the operation unit 5 and selects the item to instruct the formatting of the optical disc 2 in the menu picture, the instruction to perform the formatting of the optical disk 2 is issued to the main control unit 3. The monitor display apparatus 7 further has an item to cancel the format instruction. When the user operates the remote controller 4 or the operation unit 5 and selects the item to cancel the format instruction, the instruction to cancel the format instruction is issued to the main control unit 3. Through the above-mentioned operations, the monitor display apparatus 7, the main control unit 3, the remote controller 4 and the operation unit 5 constitute the format instruction means and the format instruction cancel means.

Data recording into the optical disk 2 is performed by encoding the audio signals and the visual signals generated by the received signal processing unit 17 or the signals inputted from the signal input unit 18 by the encoding unit 19 and forming pits on the optical disk 2 having predetermined lengths and arrangement corresponding to the encoded data by the optical head 6 on the basis of a signal from main control unit 3.

Data reproduction from the optical disk 2 is performed by detecting the pits formed on the optical disk 2 by the optical head 6 and determining lengths and arrangement of the pits in the main control unit 3 on the basis of the RF signals outputted from the signal processing unit 15 to read the encoded data.

Recording tracks are formed on the optical disk 2 concentrically or convolutedly with a predetermined pitch. When the user instructs to perform the formatting of the optical disc 2 by operating the format button 51 or the format key 41, the main control unit 3 performs the formatting of the optical disc 2. When the formatting of the optical disc 2 is performed, each recording track is further divided into a plurality of sectors. In each sector, an address value for identifying each sector is previously recorded by the pits. Through the above-mentioned operations, the optical head 6 and the main control unit 3 constitute a data writing means, a data reading means, and a disc formatting means.

In the writing/reading operation of encoded data, the main control unit 3 renders the optical head 6 to radiate light beam on the optical disk 2 and to receive the reflected light as well as drives the spindle motor 11 to rotate the optical disk 2. Furthermore, the main control unit 3 detects the address value of each sector to identify the sector and performs writing or reading the encoded data in units of sectors based on the pits detected by the optical head 6 or the RF signals outputted from the signal processing unit 15.

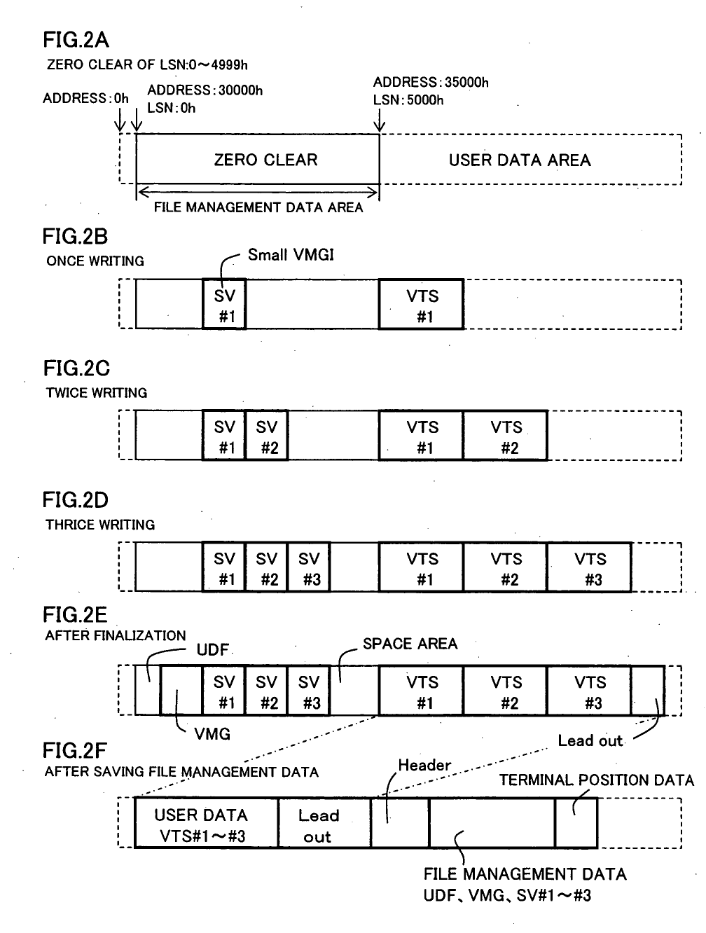

FIGS. 2A to 2F each shows a data structure of a DVD-RW in video mode in which data is recorded by the optical disk recorder 1 configured as above. These figures show changes in the data structure due to tree times of additional writings and changes in the data structure before and after finalization. The DVD-RW is an optical disk in which data can be rewritten any number up to a predetermined number of times. The DVD-RW into which a moving picture is recorded in the video mode can be reproduced as a DVD video with a DVD video player or a personal computer having DVD-ROM drive apparatus in compliance with the DVD-RW.

When a user instructs to perform the formatting of the DVD-RW, the optical disc recorder 1 erases file management data in a file management data area on the DVD-RW, thereby the DVD-RW is formatted. The file management data are data to manage user data. The user data are stored in user data areas after physical address 35000h (hexadecimal number). The physical address 35000h corresponds to LSN (Logical Sector Number) 5000h. The file management data are stored in file management data areas from physical address 30000h (LSN 0h) to 34999h (LSN 4999h).

As shown in FIG. 2A, the optical head 6 formats the DVD-RW by writing data corresponding to “0” (called “zero clear”) from physical address 30000h to 34999h based on a signal from the main control unit 3. When the user operates the optical disk recorder 1 to recode, for example, video data of one title, the optical head 6 writes VTS (Video Title Set) which is the user data into the user data area based on a signal from the main control unit 3, as shown in FIG. 2B. In addition, small VMGI (Small Video Manager Information) which is the file management data is written in the file management data area from LSN 3000h.

The VTS is a block of program information comprised of VTSI (Video Title Set Information), VTSM_VOBS (Video Objects for Video Title Set Menu), VTSTT_VOBS (Video Objects for Titles in a Video Title Set) and VTSI (BUP). The VTSI is control information of VTS, which is formed of one file named as VTS_##_0.IFO. The VTSM_VOBS is material information of a menu picture unique to the program, which is formed of one file named as VTS_##_0.VOB. The material of the menu picture includes still pictures or moving pictures. The menu picture unique to the program enables menu selection unique to the program. The VTSTT_VOBS is video information, which is formed of a plurality of files named as VTS_##_@.VOB. The VTSI (BUP) is a backup which is formed of one file named as VTS_##_0.BUP. Although the VTSM_VOBS is not necessarily required, the VTSI, the VTSTT_VOBS and the VTSI (BUP). are necessary for reproducing the video data. An integer of 01 to 99 fits in ## and an integer of 1 to 9 fits in @.

The small VMGI is file management data into which the management data of the VTS which is user data is stored. The small VMGI is formed whenever the VTS is written by one title, and corresponds to each VTS. In FIGS. 2B to 2F, a numerical reference following to the small VMGI (SV) shows the correspondence with the VTS having the same numerical reference. Each small VMGI includes a title number of the VTS, VTS_##_0.IFO, VTS_##_0.VOB, VTS_##_@.VOB, a start address of VTS_##_0.BUP and a title name.

When second additional writing of the video data is performed, a new VTS is further written into the user data area and a new small VMGI corresponding to the new VTS is further written in the file management data area, as shown in FIG. 2C. The new small VMGI is written into an area continuing to the area of the small VMGI which was already written in the first writing. The new VTS is written into an area continuing to the area of the VTS which was already written in the first writing with a border area (not shown) which shows a border of the data. The border area is composed of a border-out showing end of the data and a border-in storing a writing position data of next data. Such a data additionally writing method is called “incremental recording method” using the border.

As shown in FIG. 2D, third additional writing of the video data is performed similarly. Each VTS is written into the user data area, and the small VMGI corresponding to each VTS is written into the file management data area. When there is no space in the user data area and/or the file management data area in newly writing data into the optical disc, or when the user instructs to erase the user data already written in the optical disc, new user data and/or new file management data may be overwritten on the user data and/or the file management data already written.

FIG. 2E shows a data structure of the DVD-RW after finalization. Finalization refers to processing for prohibiting writing of additional data. Finalization also refers to processing for making media recognizable in general DVD players and DVD-ROM drives. The user can instruct the finalization to the main control unit 3 by pressing down a finalization button (not shown) provided in the operation unit 5 or operating a finalization key (not shown) provided on the remote controller 4, or by selecting an item of finalization among menus displayed on a screen of the monitor display apparatus 7. Following to the instruction of finalization by the user, the main control unit 3 drives the optical head 6 to write a VMG (Video Manager) with an address of a number such as 260h of a specific logic sector as a front address into an area between a front position of the file management data area and an area where a front small VMGI is stored. The optical head 6 further writes a file system data such as UDF (Universal Disk Format) into an area between the front position of the file management data area and an area where the VMG is stored. The optical head 6 still further writes a lead-out corresponding to a terminal area into an area outside the final sector among the sectors into which all data including the file management data and the user data are written. The lead-out indicates the terminal position of all user data.

The VMG is formed of VMGI (Video Manager Information), VMGM_VOBS (Video Objects for Video Manager Menu) and VMGI (BUP). The VMGI is control information of the whole video area, which is formed of one file named as VIDEO_TS.IFO. The VMGM_VOBS is formed of one file named as VIDEO_TS.VOB and contains material information of the menu picture displayed on the monitor display apparatus first when DVD is reproduced. The materials of the menu picture contain still pictures or moving pictures. The menu picture enables menu selection by the user. The VMGI (BUP) is a backup of the VMGI, which is formed of one file named as VIDEO_TS.BUP. Although the VMGM_VOBS is not necessarily required, the VMGI and the VMGI (BUP) are necessary for reproducing the video.

FIG. 2F shows a data structure of the DVD-RW in the video mode after saving the file management data and finalization. The ROM 26 stores a program for judging efficiency of the file management data further to operation programs of the main control unit 3. When the user operates the format key 41 or the format button 51, the main control unit 3 recognizes the indication for formatting the optical disc 2. Prior to performing the formatting of the optical disc 2, the main control unit 3 distinguishes the data in the file management data area into effective file management data which is usable and ineffective file management data which is not usable. At this time, the main control unit 3 serves as a data distinguishing means. The effective file management data includes data relating to usable user data, and further includes the VMG and the file system data after the finalization. The ineffective file management data includes data relating to unusable user data and unusable file management data due to overwriting or erasure. The main control unit 3 drives the optical head 6 to read out the effective file management data from the file management data area so as to be saved. Thus, a size of the data to be saved can be reduced.

The optical head 6 writes the extracted effective file management data in an area outside the terminal area based on a signal from the main control unit 3. The data to be written are comprised of small VMGIs #1 to #3. After finalization, the effective file management data further includes the file system data (UDF) and the VMG, as shown in FIG. 2F. When the finalization is not processed, the terminal area corresponds to the border-out, and when the finalization is processed, the terminal area corresponds to the lead-out. When the capacity of the area outside the terminal area is insufficient to be written the effective file management data, the effective file management data may be written in the area inside the terminal area.

According to such a constitution, even if the user erroneously instructs the format of the optical disc 2 to the optical disc recorder 1 and the formatting of the optical disc 2 is performed, the effective file management data are saved in the area outside of the terminal area. Thus, the saved file management data can be utilized again, although the original file management data are erased. Furthermore, since the effective file management data are saved in a specific area of the same optical disc 2, another recording media becomes unnecessary to save the data, and thereby, the cost of the optical disc recorder 1 can be reduced due to reduction on number of elements constituting the optical disc recorder 1.

As shown in FIG. 2F, a header is further written into an area between the lead-out or the border-out and the area where the effective file management data to be saved are written. Data in the header includes the data of the lead-out or the like, addresses of the file management data area before formatting, and addresses of the area where the effective file management data are saved. Thus, the saved effective file management data can be returned to the file management data area after formatting the optical disc 2. The user can use the data before the formatting by accessing the user data with using the returned file management data. A terminal position data indicating the terminal of the saved file management data is further written into an area outside the area where the effective file management data are saved.

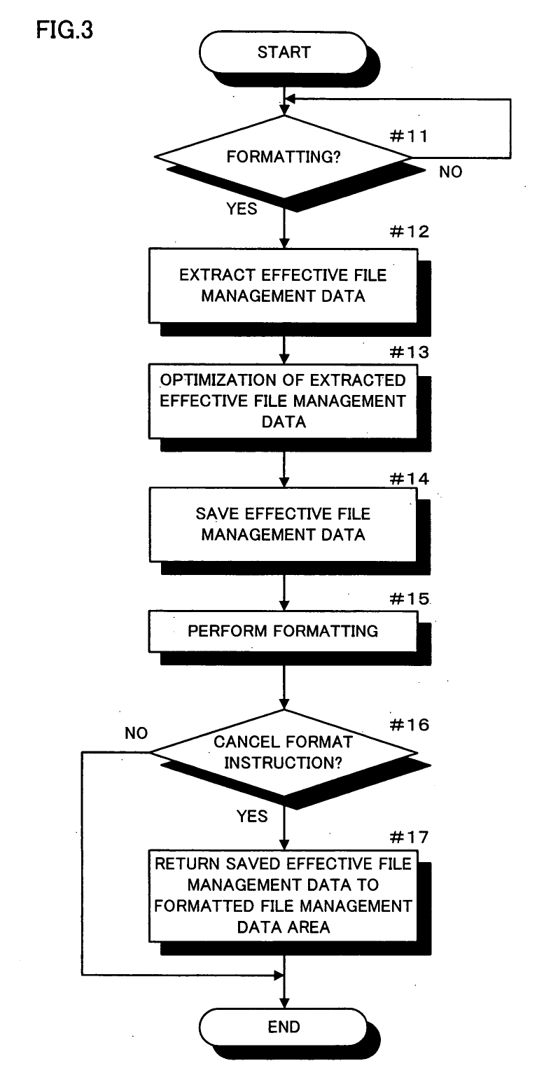

FIG. 3 shows a formatting operation of the optical disc recorder 1 in the first embodiment for formatting the optical disc 2. When the power of the optical disk recorder 1 is turned on and the user inserts the optical disk 2 into the optical disk recorder 1, the optical disk recorder 1 is put into a standby mode. When the user operates the format button 51 provided in the operation unit 5 or the format key 41 provided in the remote controller 4, or when the item for formatting the optical disc 2 is selected on the menu picture displayed on the screen of the monitor display apparatus 7 (Yes in step #11), the main control unit 3 extracts the effective file management data in the file management data area (#12). Since the main control unit 3 distinguishes the effective file management data from ineffective file management data and extracts only the effective file management data to be saved, the size of the data to be saved can be reduced. When the user does not instruct to format the optical disc 2 and to perform the other operation (No in step #11), the optical disk recorder 1 is in the standby mode.

The main control unit 3 optimizes the selected file management data (#13). A program for optimizing data is incorporated into the ROM 26 which stores the operation program of the main control unit 3 therein. Since the DVD-RW is a rewritable optical disk, data can be rewritten up to a certain number of times. In the rewriting, new file management data may be written over the written file management data. When sizes of both data are different from each other and the size of the new file management data is larger than that of the previous file management data, different data may be written at another location. The same applies also when the new file management data is written in a space area. In such a case, the file management data concerning the same user data is divided and stored in the file management data area. The main control unit 3 serving as a data optimization means combines the divided file management data which manages the same user data among the read file management data and optimizes the combined data. Thus, after erasure of the data and return of the file management data, access time to the file management data can be shortened. Furthermore, it is not necessary to access the file management data which is divided and stored in noncontiguous areas.

When the finalization is not processed, the main processing unit 3 drives the optical head 6 to write the optimized and extracted effective file management data into an area outside the border-out, and when the finalization is processed, the main processing unit 3 further drives the optical head 6 to write the optimized effective file management data into an area outside the lead-out, so as to save the effective file management data (#14). After saving the effective file management data, all the data in the file management data area are erased so that the optical disc 2 is formatted (#15).

When the user does not cancel the format instruction after formatting the optical disc 2 by operating the format cancel button 52 or the format cancel key 41 (No in step #16), a series of operations is completed. When the user operates the format cancel button 52 or the format cancel key 42, or when the user selects the item for canceling the formatting instruction in the menu picture on the screen of the monitor display apparatus 7 (Yes in step #16), the main control unit 3 drives the optical head 6 to read out the saved file management data saved in the area outside the lead-out, and rewrites the saved file management data into the file management data area to be returned thereto (#17). After that, a series of operations is completed. Through the above-mentioned procedure, the user can use the user data before formatting the optical disc 2 again based on the file management data.

According to the optical disc apparatus in accordance with the first embodiment, the effective file management data written in the file management data area can be utilized again after erasing the data in the file management data area due to formatting the optical disc 2. Furthermore, since the effective file management data is saved into a specific area of the same optical disc 2, it is no need to prepare another recording medium to save the effective file management data. Thus, the cost of the optical disc recorder 1 can be reduced due to reduction of a number of elements constituting the optical disc recorder 1.

Second Embodiment

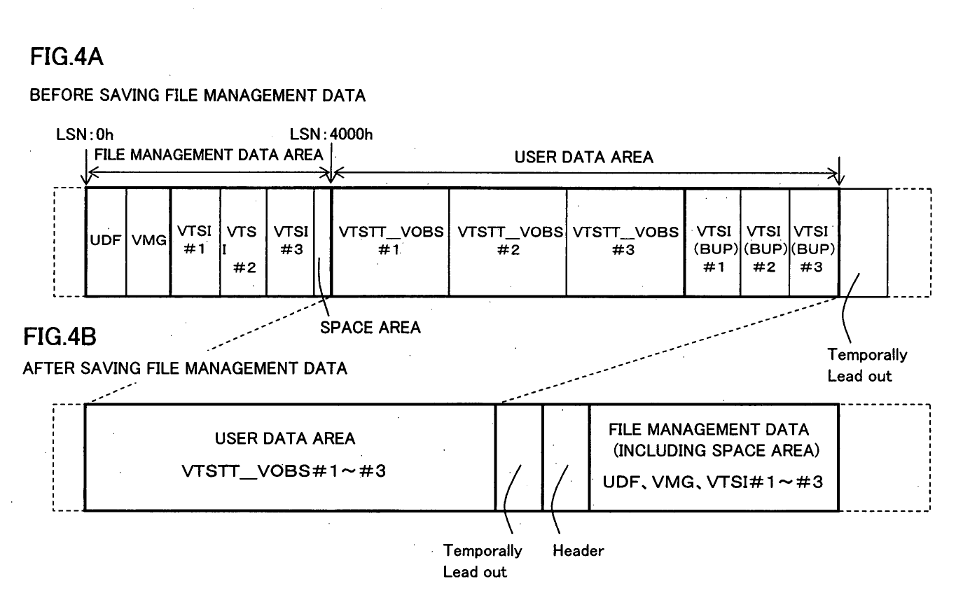

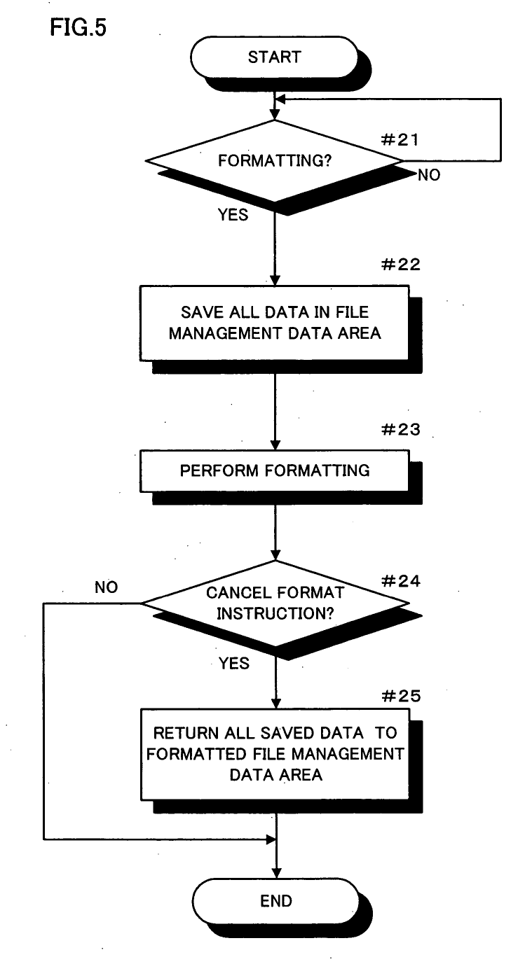

Subsequently, an optical disk recorder in accordance with a second embodiment will be described with reference to FIGS. 4 and 5. The second embodiment is different from the first embodiment in that the optical disc 2 used in the optical disc recorder 1 is DVD+RW and the mode is VR (Video Recording) mode. Constitution of the optical disc recorder 1 is substantially the same as that in the forest embodiment shown in FIG. 1, so that the description of it is omitted.

The DVD+RW is compatible with the DVD-ROM in a disk capacity and format type. Thus, it is possible to make a DVD video which can be reproduced with a DVD video player or an optical disk which can be used with a DVD-ROM drive of a personal computer with using the optical disc formatted in form of the DVD+RW. In addition, the DVD+RW can be used in a video recorder in compliance with the DVD+RW. It is possible for editing of moving picture image data and additional writing of video data into the DVD+RW (DVD+VR) that data was recorded in the VR mode. In addition, a user does not need to finalize the DVD+RW.

FIGS. 4A and 4B respectively show data structures of the DVD+RW into which data are recorded in the VR mode with the optical disc recorder 1 in the second embodiment. As shown in FIG. 4A, the file management data area extends from LSN (Logical Sector Number) 0h to 3999h. The user data area extends from LSN 4000h.

When a user operates the optical disk log device 1, for example, to recode video data of one title, the main control unit 3 drives the optical head 6 to write the VTS (management data) into the file management data area from a specific address therein. In addition, the optical head 6 writes VTSTT_VOBS (image data) and VTSI (BUP) which are user data into the user data area. The VTSI (BUP) is a backup data of the VTSI. Whenever image data of one title are written into the optical disc 2, the VTSI, the VTSTT_VOBS and the VTSI (BUP) are written into the optical disk 2. In FIG. 4A, numerical references following to the VTSI, VTSI, VTSTT_VOBS, and VTSI (BUP) correspond to a number of a title which is recorded in the optical disc 2.

When video data are additionally recorded twice or thrice, new VTSTT_VOBS is written in the user data area and the new VTSI corresponding to the new VTS is written in the file management data area. Furthermore, the VTSI (BUP) is written into the user data area. When there is no space in the user data area and/or the file management data area for newly writing data into the optical disk, or when the user instructs erasure of the written user data, the new user data and/or file management data may be overwritten over the written user data and/or file management data.

The optical head 6 writes VMG (management data of entire disk) into an area having an address earlier than that of the VTSI based on a signal from the main control unit 3. The VMG consists of the VMGI, the VMGM_VOBS and the VMGI. The optical head 6 writes a file management data such as UDF into an area between the front position of the file management data area and an area where the VMG is written. The optical head 6 further writes temporally lead-out corresponding to terminal area into an area outside the final sector among the sectors into which all data including the file management data and the user data are written. The temporally lead-out indicates the terminal position of all data.

FIG. 4B shows a data structure of the DVD+RW in the VR mode after saving the file management data. When the main control unit 3 recognizes the indication for formatting the optical disc 2, it drives the optical head 6 to read out all the data from the file management data area of the optical disc 2 prior to the formatting. The data read out from the file management data area includes the UDF, the VMG and the VTSIs #1 to #3. Subsequently, the optical head 6 writes the read data into an area outside the temporally lead-out based on a signal from the main control unit 3. When capacity of an area in the file management data area outside the temporally lead-out is insufficient to be written the read data, the read data may be written in the area of the temporally lead-out.

According to such a constitution, even when a person other than the user instructs the formatting of the optical disc 2 to the optical disc recorder 1 and the data in the file management data area are erased due to formatting of the optical disc 2, the erased data can be used again because the data are saved. Furthermore, the file management data are saved in a specific area of the optical disc 2, so that the saved data can be returned until new data are overwritten on the saved data. Still furthermore, since the file management data are saved in a specific area of the same optical disc 2 instead of another recording media, the cost of the optical disc recorder 1 can be reduced due to reduction on number of elements constituting the optical disc recorder 1.

In addition, the optical head 6 writes header into an area between the temporally lead-out and the area where the data to be saved are written. The header includes data of the temporally lead-out, addresses of the file management data area, and addresses of the areas into which the data to be saved are written. Thus, the saved file management data can be returned to original areas in the file management data area of the optical disc 2, after the formatting, and thereby, it is possible to access the user data with using the returned file management data. The user can use the data before the formatting of the optical disc 2.

FIG. 5 shows a formatting operation of the optical disc recorder 1 in the second embodiment for formatting the optical disc 2. When the power of the optical disk recorder 1 is turned on and the user inserts the optical disk 2 into the optical disk recorder 1, the optical disk recorder 1 is put into a standby mode. When the user instruct to format the optical disc 2 (Yes in step #21), the main control unit 3 drives the optical head 6 to read out all the data in the file management data area of the optical disc 2, and saves the read data in the area outside the temporally lead-out (#22). When the user does not instruct to format the optical disc 2 and to perform the other operation (No in step #21), the optical disk recorder 1 is in the standby mode.

After saving the data in the file management data area, all the data in the file management data area are erased so that the optical disc 2 is formatted (#23). When the user does not cancel the format instruction after formatting the optical disc 2 (No in step #24), a series of processes is completed. When the user instructs to cancel the formatting of the optical disc 2 (Yes in step #24), the main control unit 3 drives the optical head 6 to read out the saved file management data written in the area outside the temporally lead-out, and to rewrite the saved file management data into the file management data area to be returned thereto (#25). When the optical disc 2 is taken out from the optical disc recorder 1 and inserted into the optical disc recorder 1 again after formatting the optical disc 2, the main control unit 3 confirms whether the file management data exist or not. When there in no file management data, the main control unit 3 drives the optical head 6 to search the temporally lead-out and accesses the header positioned outside the temporally lead-out. The optical head 6 reads out the saved data based on the data of the header. After that, a series of the processes is completed. Through the above-mentioned procedure, the user can use the user data before formatting the optical disc 2 again based on the file management data.

The present invention is not limited to the configuration of the above-mentioned embodiments and can be variously modified so as not to deviate from the scope of the invention. For example, the optical disk 2 is not limited to the DVD-RW and the DVD+RW and may be a CD-RW, or a DVD-RAM. The optical disk recorder 1 is not limited to the DVD recorder and may be a DVD+RW drive, a DVD-RW drive, a DVD-RAM drive or a CD-RW drive, which are mounted in electronic equipment such as optical personal computers. The user data written into the optical disk 2 is not limited to video information and may be data such as music, sound or documents. The method for additionally writing the user data into the optical disc 2 is not limited to the incremental recording method using the border, and it may be an incremental recording method with no border which uses a loss-less linking technique to lose linking loss.

This application is based on Japanese patent application 2005-265775 filed Sep. 13, 2005 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

What is claimed is:

1. An optical disc recorder comprising:
a data writing means for writing data into an optical disc;
a data reading means for reading out data from an optical disc;
a disc formatting means for formatting an optical disc by erasing file management data written in a file management data area of the optical disc;
a format instruction means, which is operated by a user, to instruct to perform formatting of an optical disc to the disc formatting means; and
a format instruction cancel means, which is operated by the user, to instruct to cancel the formatting of the optical disc to the disc formatting means, wherein when the format instruction means instructs to perform formatting of an optical disc, the data reading means reads out file management data from file management data area of the optical disc before erasing the file management data, and the data writing means writes the file management data into a specific area of the optical disc except the file management data area so as to save the file management data, and subsequently, the disc formatting means erases the file management data originally written in the file management data area thereby formatting the optical disc; and
when the format instruction cancel means instructs to cancel the formatting of the optical disc, the data reading means reads out the file management data saved in the specific area of the optical disc, and the data writing means writes the file management data read out from the specific area into the file management data area where the file management data was originally written.

2. The optical disc recorder in accordance with claim 1 further comprising:
a data distinguishing means for distinguishing the file management data read out from the file management data area into effective file management data which is usable and ineffective file management data which is not usable, and wherein
the data writing means writes only the effective file management data into the specific area of the optical disc.

3. The optical disc recorder in accordance with claim 1 further comprising:
a data optimization means which combines divided file management data which manages a same user data among the file management data read from the file management data area of the optical disc and optimizes the combined data when the file management data concerning the same user data is divided and stored in the file management data area.

4. The optical disc recorder in accordance with claim 1
the specific area of the optical disc where the file management data are saved is located outside a terminal position of all user data stored in a user data area of the optical disc.

5. The optical disc recorder in accordance with claim 4, wherein
a header, which includes data of the terminal position of all user data, data of area where the file management data were written before formatting the optical disc, and data of the specific area where the file management data are saved, and terminal position data of the file management data saved in the specific area are further written in the specific area of the optical disc.

6. An optical disc recorder comprising:
a data writing means for writing data into an optical disc;
a data reading means for reading out data from an optical disc;
a disc formatting means for formatting an optical disc by erasing file management data written in a file management data area of the optical disc;
a format instruction means, which is operated by a user, to instruct to perform formatting of an optical disc to the disc formatting means; and
a format instruction cancel means, which is operated by the user, to instruct to cancel the formatting of the optical disc to the disc formatting means;
a data distinguishing means for distinguishing the file management data in the file management data area into effective file management data which is usable and ineffective file management data which is not usable; and
a data optimization means which combines divided file management data which manages a same user data among the file management data read from the file management data area of the optical disc, wherein
when the format instruction means instructs to perform formatting of an optical disc,
the data reading means reads out file management data from file management data area of the optical disc before erasing the file management data,
the data distinguishing means distinguishes the file management data read out from the file management data area into effective file management data and ineffective file management data,
the data optimization means optimizes the distinguished effective file management data, and
the data writing means writes only the optimized effective file management data with a header, which includes data of the terminal position of all user data, data of area where the file management data were written before formatting the optical disc, and data of the specific area where the file management data are saved, and terminal position data of the file management data saved in the specific area are further written in the specific area of the optical disc into a specific area of the optical disc except the file management data area located outside a terminal position of all user data stored in a user data area of the optical disc so as to save the effective file management data, and subsequently, the disc formatting means erases all the file management data originally written in the file management data area thereby formatting the optical disc; and
when the format instruction cancel means instructs to cancel the formatting of the optical disc, the data reading means reads out the file management data saved in the specific area of the optical disc, and the data writing means writes the file management data read out from the specific area into the file management data area where the file management data was originally written, thereby the user can use the data which were written in the optical disc before formatting.
